(19) United States
(12) Patent Application Publication
(10) Pub. No.: US 2010/0199533 A1
(43) Pub. Date: Aug. 12, 2010

(54) Display box with LEDs

(76) Inventor: Robert Tsai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,165

(22) Filed: Sep. 8, 2009

(30) Foreign Application Priority Data
Feb. 9, 2009 (TW) 098201853

(51) Int. Cl. G09F 13/18

(52) U.S. Cl. 40/546

(57) ABSTRACT

A display box includes a bottom rail, two side rails and a top rails, wherein the bottom rail includes an interior space so as to receive a switch and a rechargeable battery unit therein. The bottom rail includes two upright plates extending from a top thereof so as to define a positioning slot between the two upright plates and an LED unit is received in the positioning slot and powered by the battery unit. The LED unit includes multiple LEDs which emit different colors toward a transparent display board is positioned in the frame. The frame can be cooperated with a stand and rotatable relative to the stand.

### FIELD OF THE INVENTION

The present invention relates to a display box with Light Emitting Diodes (LEDs), and more particularly, to a pivotable display box with rechargeable battery unit.

### BACKGROUND OF THE INVENTION

A conventional display box 8 is shown in FIGS. 7 and 8, and generally includes a front frame 81, a rear frame 82 and a light plate 83 which is larger than the space enclosed by the front frame 81 and clamped between the front and rear frames 81, 82. Multiple SMT LEDs 84 are attached to sides of the light plate 83 and a poster 85 is connected with the light plate 83. The poster 85 is protected by a protection film 86 which includes positioning members 861 to ensure that the poster 85 is securely attached to the light plate 83.

However, the display box 8 is integrally connected with the electrical wire 87 so that the display box 8 has to be powered by a plug-in device which is difficult be found in some areas. Besides, the frame 8 has to be made by metal such that the positioning members 861 on the protection film 86 can be attached on it. The frame 8 is easily rusted and heavy which is not convenient to be transported. Furthermore, the display box 8 is fixed and cannot be seen in different directions.

The present invention intends to provide a display box which can be rotated about a stand and includes rechargeable battery unit which does not need to be connected with AC power.

### SUMMARY OF THE INVENTION

The present invention relates to a display box which comprises a frame including a bottom rail, two side rails connected to two ends of the bottom rail, and a top rails connected between the two side rails. The bottom rail has an interior space defined therein so as to receive a switch and a battery unit therein. The bottom rail includes two upright plates extending from a top thereof so as to define a positioning slot between the two upright plates and an LED unit is received in the positioning slot. Each of the two side rails is a U-shaped plate which includes a guide slot defined between two elongate plates. The top rail includes two parallel elongate boards and a gap is defined between the two elongate boards. The two elongate plates of each of the two guide slots are engaged with the gap by their end portions. At least one display board made of transparent material is inserted through the gap from a top of the top rail and two sides of the at least one display board are engaged with the two respective guide slots. A lower end of the at least one display board is engaged with the positioning slot of the bottom rail. The LED unit includes multiple LEDs which emit different colors toward the display board.

The primary object of the present invention is to provide a display box which is powered by the rechargeable battery unit so that the display box can be used without AC power receptacles.

Another object of the present invention is to provide a display box which is rotatable relative to a stand so that people can see the poster in the display box from different positions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the display box of the present invention;

FIG. 2 is an exploded view to show the display box of the present invention;

FIG. 3 is an enlarged view to show the bottom rail of the frame of the display box of the present invention;

FIG. 4 is an exploded view to show the stand and the frame of the display box of the present invention;

FIG. 4a shows another embodiment of the stand and the frame of the display box of the present invention;

FIG. 5 is a cross sectional view to show that one display board is received in the frame of the display box of the present invention;

FIG. 6 is a cross sectional view to show that two display boards and a poster are received in the frame of the display box of the present invention;

FIG. 7 is an exploded view to show the conventional display box, and

FIG. 8 shows that the conventional display box is integrally connected with the electrical wire.

### DETAILED DESCRIPTION OF THE PREFERRED EMBODIMENT

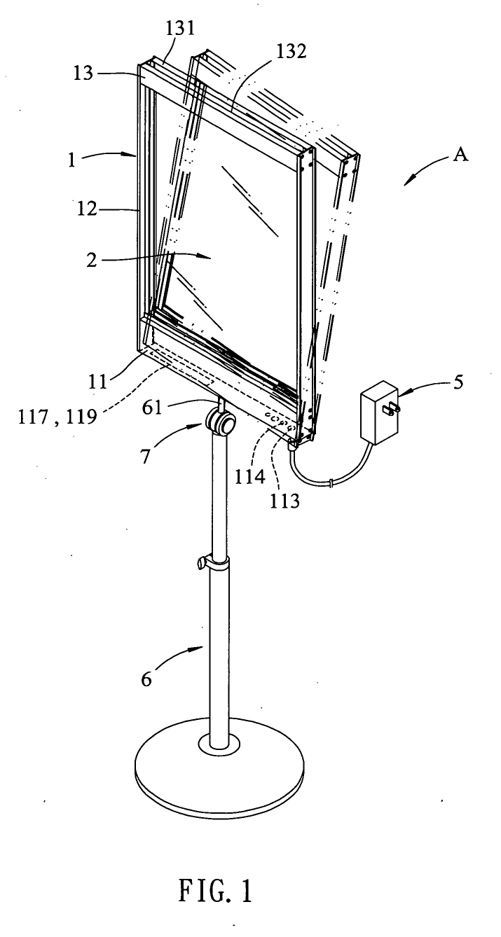

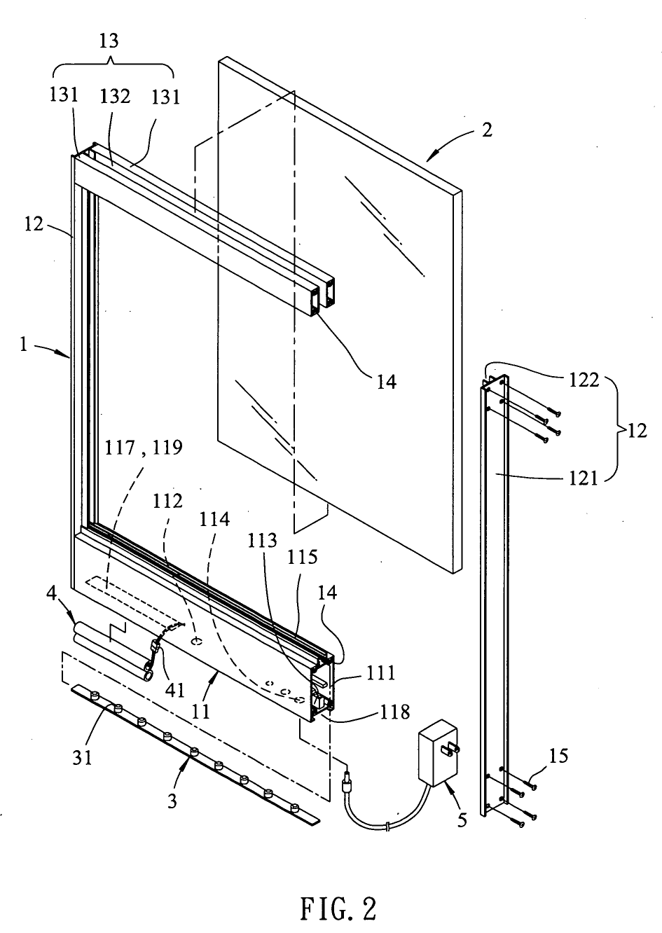

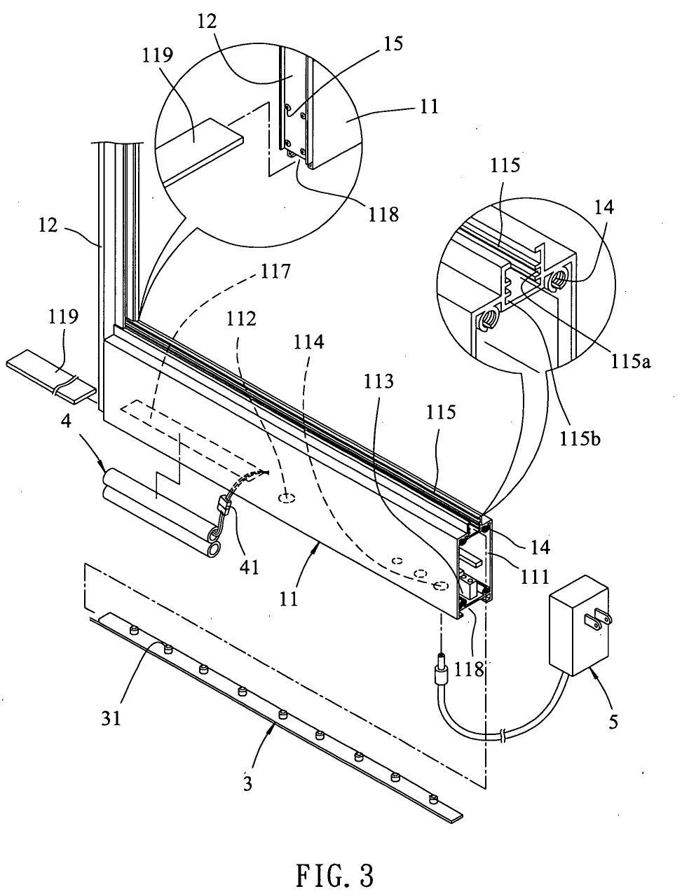

Referring to FIGS. 1 to 3, the display box “A” of the present invention comprises a frame 1 including a bottom rail 11, two side rails 12 connected to two ends of the bottom rail 11, and a top rails 13 connected between the two side rails 12 so as to from the rectangular frame 1. The bottom rail 11 has an interior space 111 defined therein and an insertion hole 112 and a charging hole 114 are defined through a underside of the bottom rail 11. A switch 113 for operation of the display box “A” is located in the interior space 111. Two upright plates extend from the top of the bottom rail 11 so as to define a positioning slot 115 between the two upright plates. The two upright plates defining the positioning slot 115 includes two first groove 115a and two second groove 115b defined in two insides thereof. An LED unit 3 is inserted into the first groove 115a.

Each of the two side rails 12 a U-shaped plate 121 which includes a guide slot 122 defined between two elongate plates. The two respective guide slots 122 of the two side rails 12 face toward the other. The two side rails 12 are connected to the bottom rail 11 and the top rail 13 by screws 15 which extend through the two side rails 12 and are threadedly connected with the threaded. holes 14 in the bottom rail 11 and threaded holes in the top rail 13.

The top rail 13 is composed of two parallel elongate boards 131 and a gap 132 is defined between the two elongate boards 131. The two elongate plates of each of the two guide slots 122 are engaged with the gap 132 by their top ends when connecting to the top rail 13.

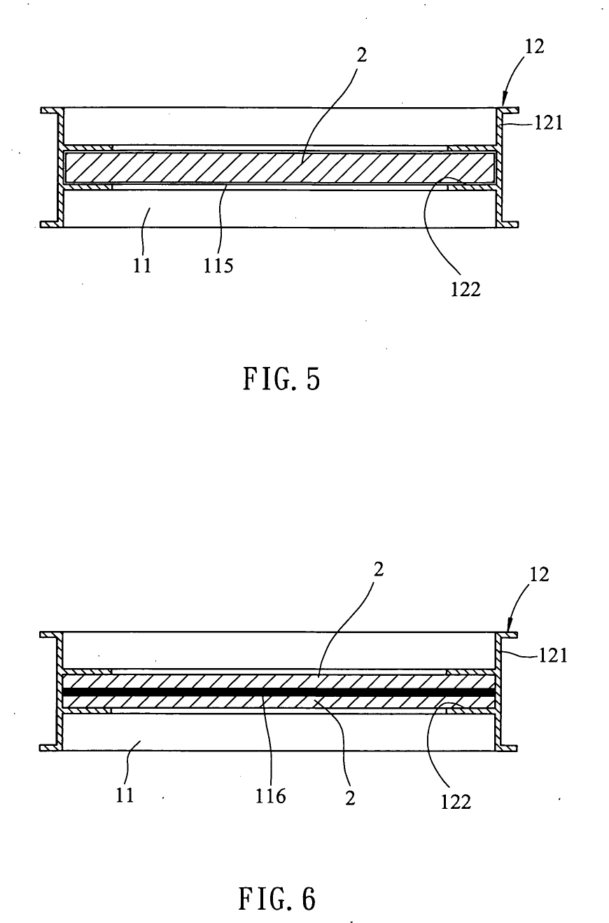

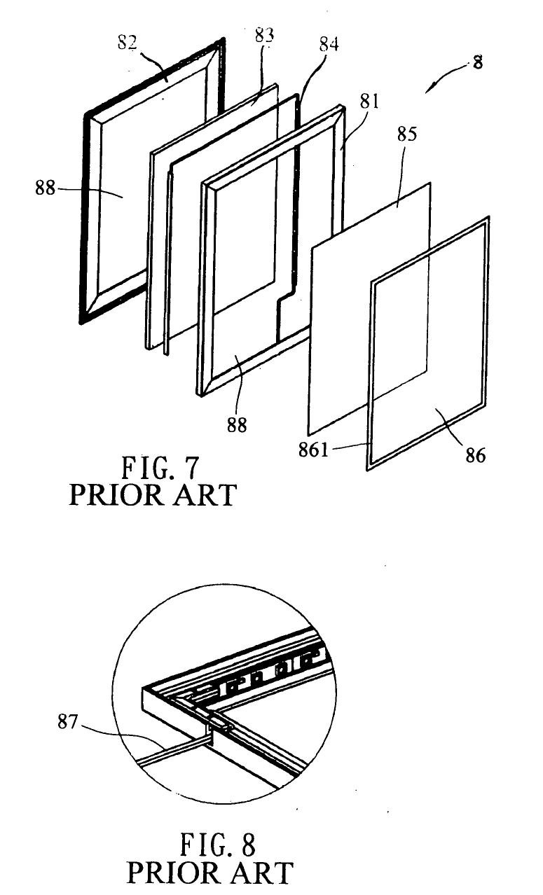

A display board 2 made of transparent material such as Acrylic or glass is inserted through the gap 132 from top of the top rail 13 and two sides of the display board 2 are engaged with the two respective guide slots 122. The lower end of the display board 2 is engaged with the positioning slot 115 of the bottom rail 11 as shown in FIG. 5.

The LED unit 3 is received in the positioning slot 115 of the bottom rail 11 and includes multiple LEDs 31 which emit different colors of light toward the display board 2. An opening 117 is defined in the underside of the bottom rail 11 and a battery unit 4 is received in the bottom rail 11 via the opening 117. A second slot 118 is defined in the underside of the bottom rail 11 and a cover 119 is slidably engaged with the second slot 118 so as to cover the opening 117. The battery unit 4 powers the LED unit 3 and is connected with an AC/DC adaptor which allows the display box “A” to be powered by AC power when available. It is noted that the battery unit 4 includes rechargeable batteries so that the rechargeable batteries can be charged by using the AC/DC adaptor. When the battery unit 4 needs to be replaced or maintained, the cover 119 can be slid along the second slot 118 so that the user can dis-connect the battery unit 4 from the connector 41 and a new battery unit 4 is connected to the connector 41.

The display board 2 can be drawn with patterns or the like by fluorescent pens and the LEDs 31 provide different colors of light to display the patterns on the display board 2 in a fancy way.

As shown in FIG. 6, there can be two display boards 2 with a poster 116 clamped therebetween and the user turns on the display box “A” by the switch 113 and the LEDs 31 emit different colors of light from the lower end of the display boards 2 to illuminate the poster 116 to attract people's attention.

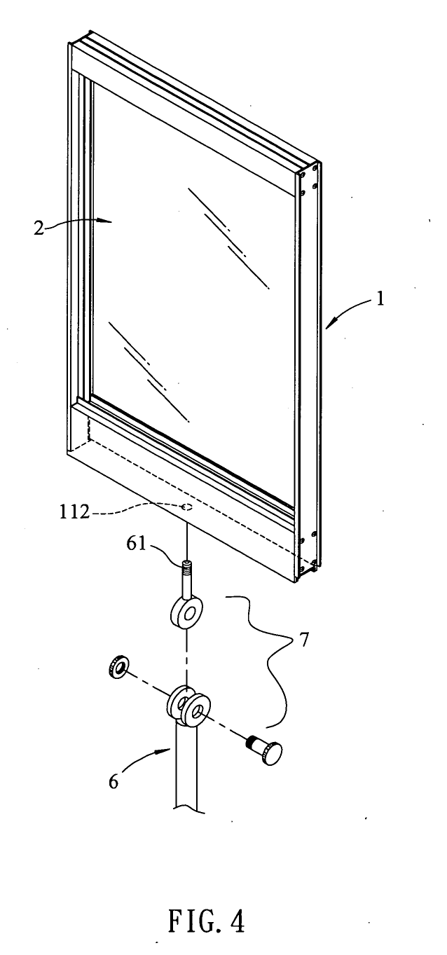

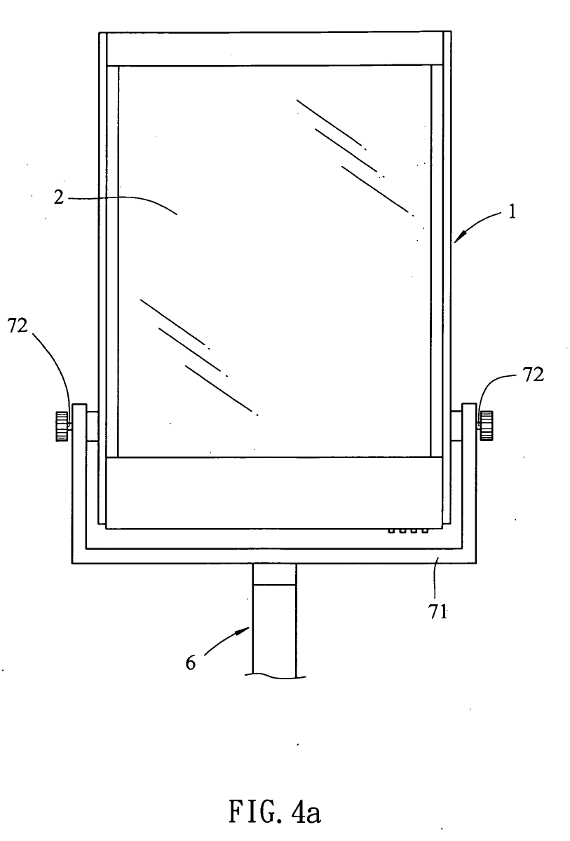

Further referring to FIG. 4, a stand 6 includes a pivotal bolt 61 which is inserted into the insertion hole 112 in the bottle rail 11 so that the frame 1 is rotatable relative to the stand 6. A pivotal device 7 is connected between the stand. 6 and the pivotal bolt 61 so that the frame 1 can be set at an angle when needed.

FIG. 4a shows that the pivotal device 7 can be replaced by a U-shaped support device 71 which has two upright arms which are located on two sides of the frame 1 and bolts 72 are used to connect the two arms of the U-shaped support device 71 to the two sides of the frame 1. By adjusting the bolts 72 and the frame 1 can be set at desired angular position relative to the two arms.

While we have shown and described the embodiment in accordance with the present invention, it should be clear to those skilled in the art that further embodiments may be made without departing from the scope of the present invention.

What is claimed is:

1. A display box comprising:
a frame including a bottom rail, two side rails connected to two ends of the bottom rail, and a top rails connected between the two side rails so as to from a rectangular frame, the bottom rail having an interior space defined therein and an insertion hole defined through a underside of the bottom rail, a switch located in the interior space and a charging hole defined in the underside of the bottom rail, the bottom rail including two upright plates extending from a top thereof so as to define a positioning slot between the two upright plates, each of the two side rails being a U-shaped plate which includes a guide slot defined between two elongate plates, the two respective guide slots of the two side rails facing toward the other, the top rail including two parallel elongate boards and a gap defined between the two elongate boards, the two elongate plates of each of the two guide slots engaged with the gap;
at least one display board made of transparent material and inserted through the gap from a top of the top rail and two sides of the at least one display board being engaged with the two respective guide slots, a lower end of the at least one display board being engaged with the positioning slot of the bottom rail;
an LED unit received in the positioning slot of the bottom rail and emitting light toward the at least one display board, the LED unit includes multiple LEDs which emit different colors, and
a battery unit powering the LED unit and located in the interior space of the bottom rail.

2. The display box as claimed in claim 1, wherein the battery unit is connected with an AC/DC adaptor.

3. The display box as claimed in claim 1, wherein the battery unit includes rechargeable batteries.

4. The display box as claimed in claim 1, wherein a stand includes a pivotal bolt which is inserted into the insertion hole in the bottle rail so that the frame is rotatable relative to the stand.

5. The display box as claimed in claim 4, wherein a pivotal device is connected between the stand and the pivotal bolt.

6. The display box as claimed in claim 1, wherein the at least one display board is made of Acrylic or glass.

7. The display box as claimed in claim 1, wherein the two upright plates defining the positioning slot includes two first groove and two second groove defined in two insides thereof, the LED unit is inserted into the first groove.

8. The display box as claimed in claim 1, wherein an opening is defined in the underside of the bottom rail and the battery unit is received in the bottom rail via the opening, a second slot is defined in the underside of the bottom rail and a cover is slidably engaged with the second slot so as to cover the opening.
